(19) United States
(12) Patent Application Publication
(10) Pub. No.: US 2019/0080294 A1
(43) Pub. Date: Mar. 14, 2019

(54) COMPUTERIZED SYSTEM AND METHODS FOR GENERATING CUSTOMIZED PERSONNEL PACKAGES

(71) Applicant: STABILITY HEALTHCARE, INC., Los Angeles, CA (US)

(72) Inventors: JAY BLECKER, LOS ANGELES, CA (US); JON CHESNIK, LOS ANGELES, CA (US); CRISPIN LUNA, LOS ANGELES, CA (US)

(73) Assignee: STABILITY HEALTHCARE, INC., Los Angeles, CA (US)

(21) Appl. No.: 15/917,572

(22) Filed: Mar. 10, 2018

Related U.S. Application Data
(60) Provisional application No. 62/470,087, filed on Mar. 10, 2017.

(51) Int. Cl. G06Q 10/10; G06Q 10/06

(52) U.S. Cl. CPC G06Q 10/1057; G06Q 10/063112; G06Q 10/06398; G06Q 10/1053

(57) ABSTRACT

Computerized systems and methods for generating customized personnel packages which comprise a Vendor Management Services (VMS) Integrator that receives aggregated jobs data from a database and parses out jobs details and reformats the jobs details into a standardized data format. The invention includes a custom customer relationship management (CCRM) database which stores information relevant to a pay package from a particular facility. The standardized jobs details from the VMS Integrator are then used as a key to retrieve from the CCRM database the pay rules, facility contracts, and facility rate sheets for the facility associated with the standardized job details. The invention further includes a custom bill pay generator which applies and blends the job details using custom logic, in accordance with the facility rate sheet, blending rules, business rules, and gross profit rules, to generate a custom pay package.

### CROSS-REFERENCE TO RELATED APPLICATION

This application claims the benefit of and priority from U.S. provisional application No. 62/470,087 filed on Mar. 10, 2017 and entitled COMPUTERIZED SYSTEM AND METHODS FOR GENERATING CUSTOMIZED PERSONNEL PACKAGES. The contents of the above application are hereby incorporated herein by reference in full.

### FIELD OF THE INVENTION

The present invention relates to methods and a system for generating customized personnel packages.

### BACKGROUND OF THE INVENTION

Often, job applicants, such as travel nurses, apply for temporary or seasonal job openings through an agency. An agency often has a contract with its clients (such as, for example, hospitals, facilities, or other employers) (in the descriptions of preferred embodiments below, each of these shall be referred to individually as a “facility” and collectively as “facilities”). The contract often specifies how much the agency will get paid for filling one of the facility's job openings. An agency employs recruiters, who match an applicant with potential job openings, compare the applicant's preferences to the requirements for the potential job openings, and then transmit a completed application to a facility.

### SUMMARY OF THE PREFERRED EMBODIMENTS

The present invention is a computerized system and methods for generating customized personnel packages.

### BRIEF DESCRIPTION OF THE DRAWINGS

The invention may be more readily understood by referring to the accompanying drawings in which:

FIG. 1 is a diagram showing logical functions performed by and the flow of data within a preferred embodiment of the present invention during operation;

FIG. 2 is a diagram showing the calculation of a pay package by a preferred embodiment of the present invention;

FIG. 3 is a chart showing the steps performed during a complete placement by a preferred embodiment of the present invention;

FIG. 4 is a diagram showing the steps for enrolling an applicant and creating an application package performed by a preferred embodiment of the present invention;

FIGS. 5-1 and 5-2 are a database schema showing database tables used for storing and retrieving data in a preferred embodiment of the present invention;

FIG. 6 is a diagram providing an overview of the blended bill rate calculation performed by a preferred embodiment of the present invention;

FIG. 7 is a diagram showing a submittal process for an applicant in a preferred embodiment of the present invention;

FIG. 8 is a diagram showing the flow of data for validating an applicant's qualifying factors in a preferred embodiment of the present invention;

FIG. 9 is an overview diagram showing the high-level steps performed to create a bill package in a preferred embodiment of the present invention; and

FIGS. 10-14 are tables showing the calculation of pay packages under various approaches in a preferred embodiment of the present invention.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or another embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). The various components of the present invention, are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, or the like, or macros using Excel or other similar or related applications with various algorithms being implemented with any combination of data structures, objects, processes, routines or other programming elements.

Referring now to the drawings, wherein the showings are for purposes of illustrating the present invention and not for purposes of limiting the same, in a preferred embodiment of the present invention,

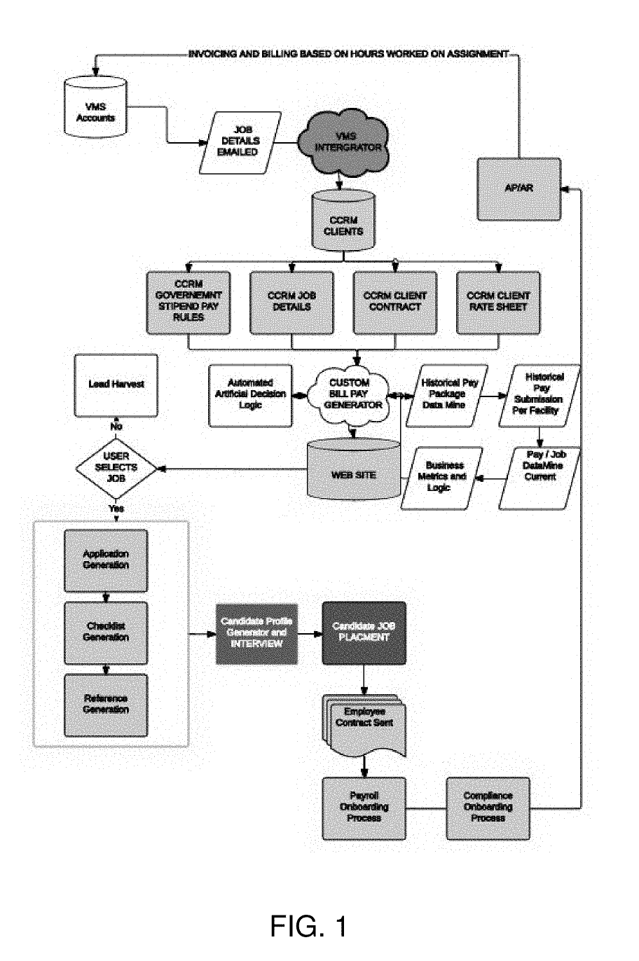

FIG. 1 is a diagram showing logical functions performed by and the flow of data within a preferred embodiment of the present invention during operation. As shown in FIG. 1, preferably, the present invention includes a Vendor Management Services (VMS) Integrator. A VMS is a service that aggregates data pertaining to a facility's needs. Generally, a VMS aggregates data pertaining to the available jobs (“jobs data”) from one or more facilities (for example, hospitals). However, a VMS can aggregate data pertaining to any of a facility's needs, such as data necessary to track the facility's purchasing. Thus, in the case of hospitals, a VMS can aggregate data pertaining to different types of staffing, including nurse staffing, admin staffing, and the like. Further, by way of example, a VMS could aggregate jobs data from a group of hospitals within a particular region. The jobs data aggregated by the VMS is then stored in a VMS database. The VMS Integrator receives the aggregated jobs data from the VMS database. In a preferred embodiment, the VMS Integrator receives the aggregated jobs data from the VMS database through an XML feed. However, those of ordinary skill in the art will appreciate that the VMS Integrator can receive aggregated jobs data by email, from a comma-separated value (CSV) feed, from a rich site summary (RSS) feed, or via any other method of transmitting digital data. Those of ordinary skill in the art will also appreciate that the VMS database may be an external service. The VMS Integrator then parses out jobs details from the aggregated jobs data and reformats the jobs details into a standardized data format. Thus, if there are multiple VMS s providing aggregated jobs data in different formats, the VMS Integrator parses out jobs details from the aggregated jobs data from each of the various VMSs and then exports the jobs details in the same data format regardless of which VMS provided the aggregated jobs data.

Preferably, the present invention includes a custom customer relationship management (CCRM) database, which stores information relevant to a pay package from a particular facility, such as pay rules, facility contracts, and facility rate sheets. For example, in a preferred embodiment, the CCRM database stores government stipend pay rules, facility contracts, and facility rate sheet(s) pertaining to a particular facility. The government stipend rules govern the use of a stipend to generate a pay package that includes compensation for travel and W2 wages, the facility contract specifies how the agency is paid, and the facility rate sheet specifies the bill rate that the facility pays the agency. For example, the facility rate sheet may specify that the agency will get paid a higher rate for filling a job opening with nurses in a particular specialty area.

The standardized jobs details from the VMS Integrator are then used as a key to retrieve from the CCRM database the pay rules, facility contracts, and facility rate sheets for the facility associated with the standardized job details. Preferably, the standardized jobs details are also stored in the CCRM database.

Further as shown in FIG. 1, the present invention includes a custom bill pay generator. In a preferred embodiment, the custom bill pay generator receives the standardized jobs details from the CCRM database. However, the custom bill pay generator can also receive the standardized job details directly from the VMS Integrator. The custom bill pay generator also receives from the CCRM database the pay rules, facility contracts, and facility rate sheet for the facility. The custom bill pay generator then applies and blends the job details using custom logic described herein, in accordance with the facility rate sheet, blending rules, business rules, and gross profit rules, to generate a custom pay package.

The business rules applied by the custom bill pay generator may be based on a gross profit calculated by the agency for a given applicant. Gross profit can be based on the billing rates, the stipend, or the type of job that an applicant is being placed with.

In a preferred embodiment, the CCRM database stores historical rate data, that is, the rates previously paid by facilities to particular applicants. The custom bill pay generator then uses the historical rate data in the CCRM database to generate a job. By way of non-limiting example, if a facility is “Hospital A” in Los Angeles, and is offering a job with a rate of $65, the CCRM database might have a historical collection of pay packages, with those two variables, that have been previously offered. The custom bill pay generator can then use that data to determine what the average blend was for those historical pay packages, and then generate a new pay package online.

Preferably, the historical rate data in the CCRM database has been entered by recruiters, who store their pay packages into the database. Thus, the custom bill pay generator can use the historical rate data. The custom bill pay generator thus has artificial intelligence to create custom pay packages online using the historical rate data, using fixed variables or fixed multipliers, or any combination thereof.

In a preferred embodiment, the present invention includes a website that then presents to an applicant the pay package determined by the custom bill pay generator. The website allows a user to either select or decline a job associated with the pay package. If an applicant declines the job, the data is stored so that sales personnel can harvest the lead. If an applicant selects the job, the user is then asked questions necessary to generate one or any combination of an application, a checklist, and a list of references.

Preferably, the present invention also includes a candidate profile generator, which generates a profile for the applicant, and then the applicant can be interviewed. If the facility then approves the applicant for the position, there would then be a job placement. Finally, the applicant is presented with an employee contract. The applicant is then onboarded with payroll and then compliance, which is a function that ensures that the applicant meets all of the facility's criteria. By way of example, the compliance function could verify that the applicant has completed licensing requirements and all of the things that job or that facility requires for submission.

Then, after completing the payroll onboarding and compliance onboarding processes, the applicant's data is then sent to accounts payable and accounts receivable, which is where the agency is able to differentiate between what the agency is paying the applicant, and what the agency is billing the facility for that placement. Thus, from an account payable perspective, the agency determines what it is paying to the applicant through payroll. The accounts receivable records the amounts paid by the facility to the agency. Then, the agency can submit its bill or invoice to the facilities through the VMS, and the VMS connects to the agency's facilities.

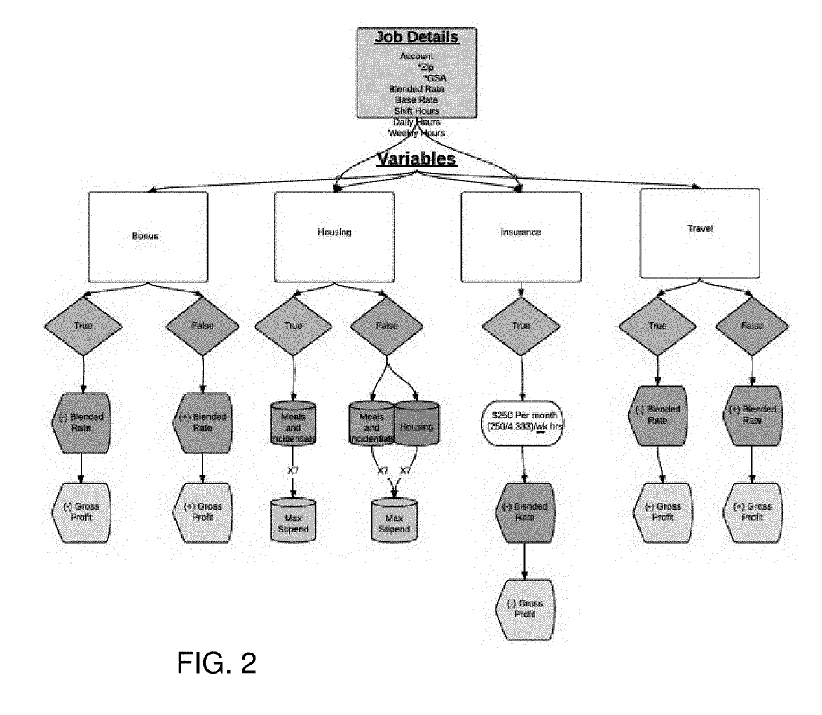

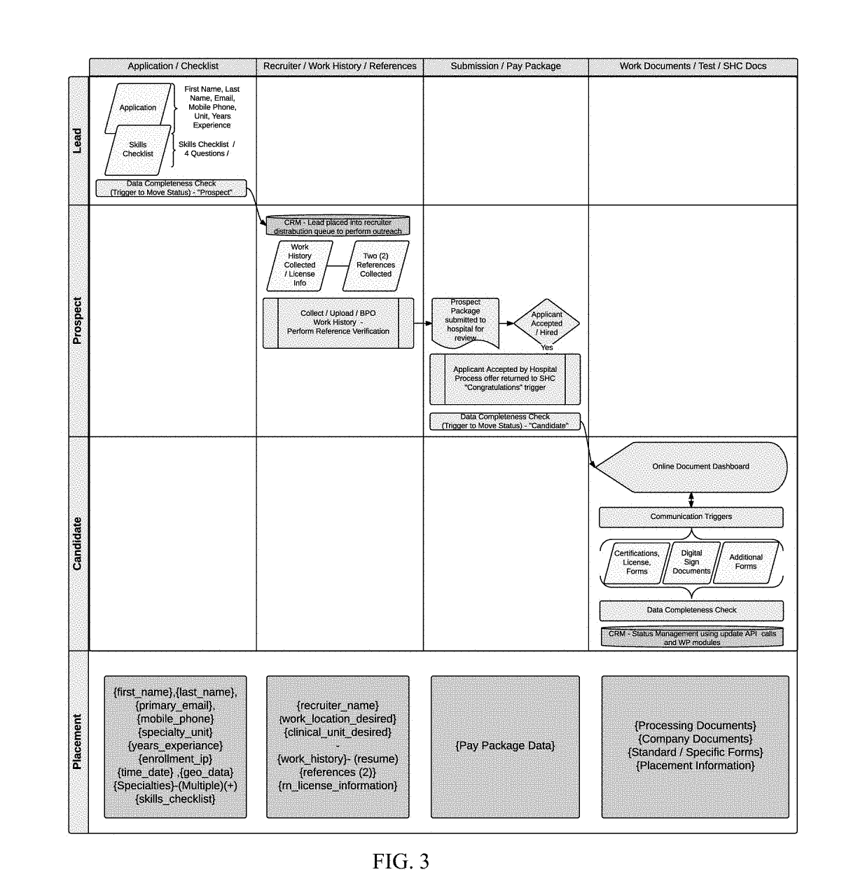

FIG. 2 is a diagram showing how certain variables can affect the gross profit earned by the agency and thus the calculation of a pay package. As shown in FIG. 2, the job detail can include account, zip, General Service Administration (GSA) per diems, blended rate, base rate, shift hours, daily hours, and weekly hours, or the like. There are also variables (or “buckets”) pertaining to bonus, housing, insurance, travel, or other variables which affect the calculation of a gross profit. As shown in FIG. 2, gross profit is affected based on true and false decisions pertaining to one or more of those variables.

By way of example, an agency has the ability to offer an applicant a sign-on bonus or a bonus as an incentive for taking a certain job. If the applicant elects to accept the bonus, the “true” decision path is followed, and if the applicant declines to accept the bonus, the “false” decision path is followed. As shown in FIG. 2, the true and false decision paths affect a blended rate in different ways.

The calculation of a blended rate is described as follows. Normally, the agency is provided a bill rate by its facilities. However, in a preferred embodiment, formulas that exist within the industry are applied to that bill rate to calculate a blended rate. The blended rate takes into account rules that govern the rate at which the applicant is paid, such as laws and labor regulations. By way of example, if the job details indicate a 10 hour work shift, and the job takes place in a state which mandates an overtime pay rate for hours worked beyond a regular 8 hour shift, then 8 of the hours in that shift would be paid at the bill rate for regular hours, and 2 of the hours would be paid at the overtime rate. Preferably, the system applies a number of rules governing how overtime and regular time are blended, to provide a blended rate, which represents the final “true” hourly rate presented to an applicant.

The various buckets are calculated to create a pay package for the applicant. By way of example, in a preferred embodiment, each of the buckets shown in FIG. 2—bonus, housing, insurance and travel—have factors that drive or determine how much in that bucket can be allocated, to create a complete pay package. Thus, in a preferred embodiment, the system takes bill rate information from the facility and then determines, based on that bill rate, how applicants can have the most amount of control over determining how to maximize their total pay.

As shown in FIG. 2, some of the buckets, such as insurance, can be factored into the calculation of pay package without the applicant selecting an allocation. However, in a preferred embodiment, the bonus base, the housing base, and the travel buckets can be affected by the applicant's true or false decisions. By way of example, if an applicant plans to move across the country to fill a job opening, the applicant may want to elect what is called an advance, or a travel advance. The applicant might want a larger amount up front, because they're going all the way across the country. So the applicant would want to be compensated more to cover the costs of getting across the country, rather than wanting more of the money in housing costs.

Thus, as shown in FIG. 2, in a preferred embodiment, the applicant can select those buckets where they would like more of their pay allocated. Preferably, on the back end, the system considers the bill rate and maintains a minimum level of profit margin for the agency, in calculating the blended rate.

By way of example, as shown in FIG. 2, if the applicant elects to receive a bonus, that bonus would be paid out of the applicant's W2 wages. Thus, the blended rate is decreased and the agency's gross profit is decreased, to reflect increased payroll costs. If the applicant elects not to receive a bonus, the blended rate is increased and the agency's gross profit is increased.

Further, by way of example, as shown in FIG. 2, in a preferred embodiment, an applicant can either elect to have housing provided by the agency, or to receive cash and find housing on his own. This election affects a maximum stipend, which is received by the applicant for housing and for meals and incidentals. By way of example, as shown in FIG. 2, the cost of meals and incidentals is retrieved from a database and factors into the calculation of the maximum stipend. Then, if the applicant elects to have housing provided by the agency, the “true” decision path is followed and the maximum stipend is not affected. If the applicant elects not to have housing provided by the agency, the “false” decision path is followed, and preferably, a query is performed on a housing database storing housing options and costs, and the cost of housing correspondingly increases the maximum stipend received by the applicant. Further as shown in FIG. 2, in a preferred embodiment, the cost of meals and incidentals are received from government databases as a daily cost, and are then multiplied by seven to reflect a weekly cost. Preferably, the cost of housing is also stored as a daily cost and then multiplied by seven to reflect a weekly cost.

Preferably, the housing database is updated to reflect changes in the cost of housing, including seasonal changes. For example, a condo in the summer in Miami is less expensive than a condo in Miami in the winter.

Further as shown in FIG. 2, in a preferred embodiment, the Insurance bucket is automatically selected and factored into the calculations of the blended rate and the agency's gross profit.

Preferably, the calculation of the blended rate and of the agency's gross profits will be based on the buckets of bonus, housing, insurance, and travel, as shown in FIG. 2. However, those of ordinary skill in the art will appreciate that any bucket or combination of buckets that might affect the calculation of blended rate and of the agency's gross profits can be considered. For example, a facility might choose to offer a completion bonus to an applicant. Thus, that completion bonus could also decrease the blended rate and gross profits.

FIG. 3 is a chart demonstrating a complete placement of an applicant in accordance with a preferred embodiment. Moving from left to right, FIG. 3 demonstrates the steps performed and the data used during the application process, to place the applicant in a position.

As shown in the upper left square of the chart in FIG. 3, during the application process, the applicant, through a user interface presented by the website, fills out the application with the applicant's first and last name, contact information, specialty unit, and years of experience, and then completes a checklist with information pertaining to his skillset, including specialties and other relevant data. The lower left square of the chart in FIG. 3 shows the variable names of the data collected from the applicant during this step in a preferred embodiment.

As shown in the second column in the chart of FIG. 3, in a preferred embodiment, location and clinical unit preferences, licensing information, and work history are then collected from the applicant, as the applicant is now considered a prospect. Further, two references are collected. The applicant's information is also placed into a recruiter distribution queue, so that a recruiter can reach out to the applicant. Preferably, the applicant's information is also sent to a business process outsource (BPO) for validation and formatting (if necessary). In a preferred embodiment, the references are then verified. Thus, at this step, the applicant is complete as a prospect, and the system has gathered a recruiter's name associated to the account, a work location desired, a clinical unit desired, a work history and/or resume, references, and licensing information.

As shown in the third column of the chart in FIG. 3, preferably, a prospect package is submitted to a facility or hospital for review. If the applicant gets hired by the facility, the applicant then gets a hospital prospect offer returned to the agency. A “congratulations” message is triggered, and then a data completeness check is performed. As shown in the bottom row of the chart, preferably, the pay package data is now complete.

As shown in the fourth column of the chart in FIG. 3, preferably, the present invention includes an online document dashboard, for receiving and verifying certifications, licenses, and forms, and for the applicant to digitally sign any documents. Here, the compliance function discussed above in the discussion of FIG. 1 is performed. Thus, this step allows the applicant to upload documents, store the documents, and tag the documents. The bottom row of the chart in FIG. 3 shows some of the information that is received and stored in a preferred embodiment.

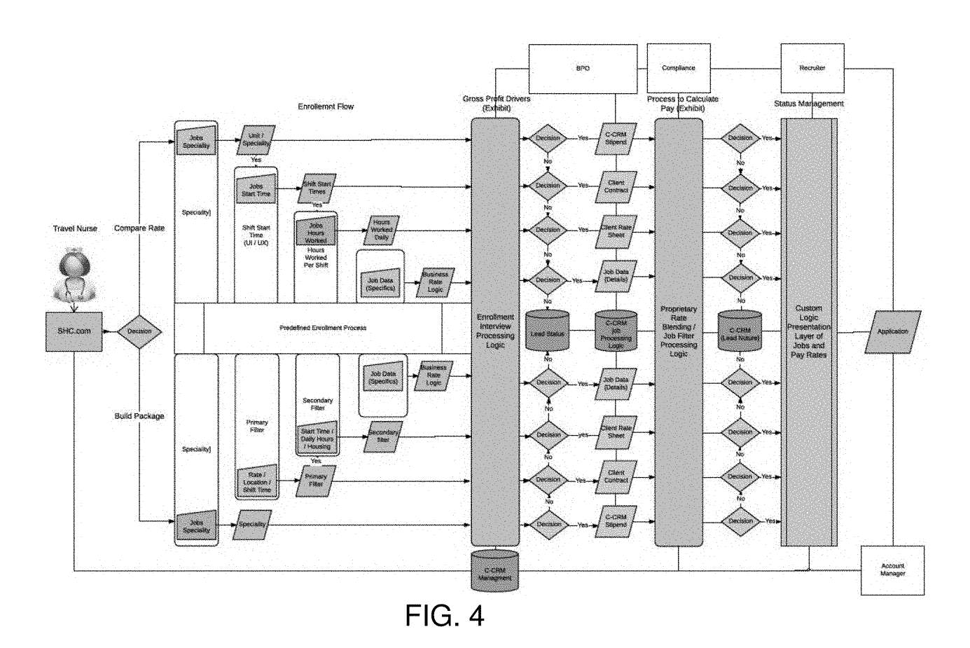

FIG. 4 is a detailed diagram showing the steps of a preferred embodiment for enrolling a nurse and creating an application package. In a preferred embodiment, there are two approaches to enrolling an applicant: a “compare rate” approach and a “build package” approach. The “compare rate” approach allows the applicant to compare the rate he is receiving at his current workplace, or in his current location or area, to a pay package for a potentially new placement. The “build package” approach builds a custom pay package based on the filters shown in FIG. 4.

The approaches shown in FIG. 4 use different logic, but technically use the same data, viewed differently. By way of example, if an applicant chooses to compare his rate, the “compare rate” approach will be followed. As shown in FIG. 4, the applicant is prompted for his specialty. This is because the pay rates will only be comparable within a specialty. For example, if the applicant is an ER nurse, he would want to compare his current ER position to only another ER job. Thus, the system will select for comparison only jobs within the ER specialty unit.

In a preferred embodiment, the next step is to try to filter and refine the list of jobs for comparison, based on shift time. That is, the applicant will provide the shift time for his current job, and preferably, only jobs having the same or a similar shift time will be considered for comparison, as the shift time affects the billing rate.

In a preferred embodiment, the list of jobs for comparison is further narrowed based on the number of hours worked in a shift. That is, how many hours the applicant has worked (for example, an applicant might be currently working eight, ten or twelve hour shifts).

In a preferred embodiment, the applicant is also asked for his location, which is then used to pull jobs located in the same or similar locations for comparison.

Preferably, at this point, job details are retrieved from the VMS based on the filters discussed above, and presented for comparison. In a preferred embodiment, the business rate logic, which affects the rate, is then applied and then that goes into enrollment interview processing, which is where the gross profit drivers are exhibited.

As shown in FIG. 4, the next step after the enrollment interview processing logic is to make logical decisions based on whether the system has any matches that are close to the applicant's current job, based on each of the previously provided filtering criteria. In a preferred embodiment, the applicant is then asked all these questions specifically. Preferably, as shown in FIG. 4, there is a business process outsourcing (BPO) unit for providing backend support, data entry, and validation, as discussed with the VMSs above, in order to generate the data that is going into making all of these decisions, which then flows into our how the system blends and produces a blended rate.

Then, preferably, there are decisions made through the CCRM which, if “yes,” lead to the logic that is blending, or virtual intelligence, which uses historical pay packages and existing pay packages, which recruiters have done that actually present online pay jobs packages.

In the “build package” approach, the same steps as the “compare rate” approach are taken. However, whereas during the “compare rate” approach specific questions are asked to refine a job, with the “build package” approach, the questions relate to the applicant's preferences, rather than mandatory questions, as presented by the “compare rate” approach. That is, the “compare rate” questions are refinement filters, whereas the filters in the build package approach are variable filters.

Then, as shown in FIG. 4, in a preferred embodiment, the compliance function is performed, to update the system regarding the applicant, to start up getting some of the application pulled out, and to get a recruiter involved, as there is now a pay package that the recruiter can discuss.

Any “no” decisions received after the proprietary rate blending step lead to the applicant's data being stored into the lead status, or lead nurturing, database.

As shown in FIG. 4, the next step is the application step. This step was previously referred to in the above discussions of FIGS. 1 and 3 as the “checklist” step.

In a preferred embodiment, as shown in FIG. 4, there is a BPO group that manually performs data aggregation, which then enables the comparisons. However, there is not a point in this actual process where the BPO is stopping the process or doing anything to the process. If an applicant decides that he is interested in a particular pay package, an application processor can send a document out, or the system can trigger the sending of a document. A recruiter can push the application, or the applicant can fill out the application themselves, or through the process, an account manager can also get involved with the application. In a preferred embodiment, an applicant can also begin the process at the application step, and go through the process in reverse. That is, an applicant could fill out an application, and then go backwards through the system, through the recruiter, through the pay package, and all the way back to the initial “compare rate” vs. “build package” decision point. Thus, preferably, the system works in an automated fashion as shown from left to right in FIG. 4, and the process can also work the opposite way, which is down through the management, recruiter, through the application process, until the point at which a manual pay package is presented. In a preferred embodiment, as shown in FIG. 4, a recruiter is involved at the application step to validate data inputted by the applicant and to transmit a completed application to an end user, such as a facility. However, it will be appreciated by those of ordinary skill in the art that the system can operate in an automated fashion without a recruiter to validate data or to complete the placement, such as by directly presenting a pay package to a facility through a VMS.

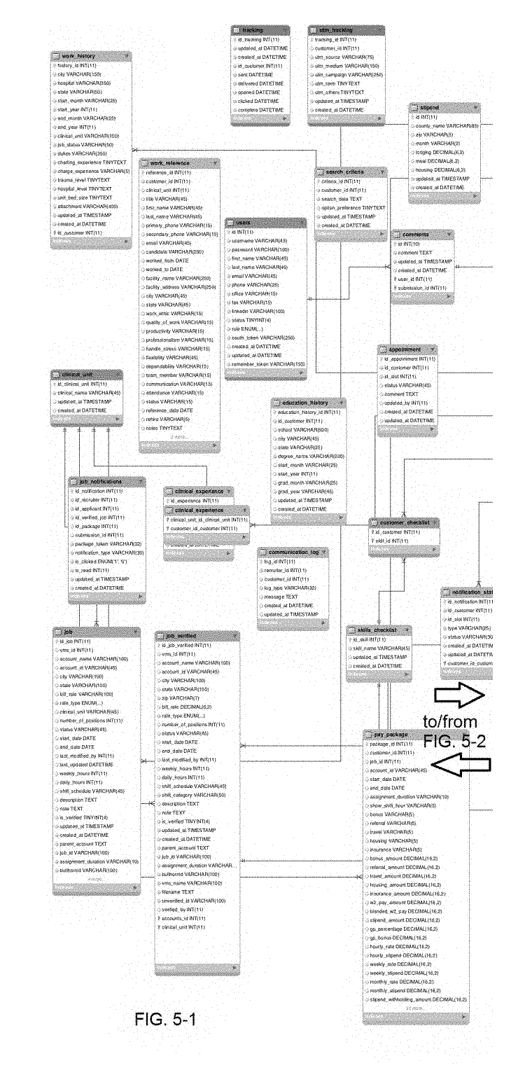

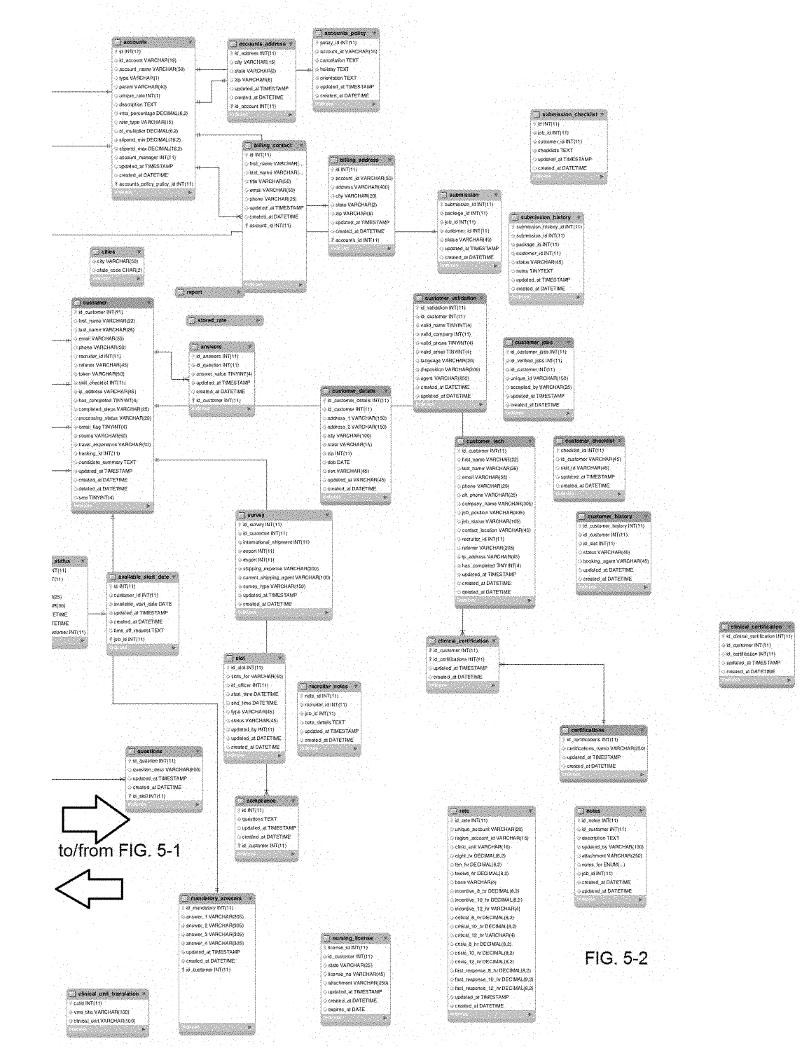

FIGS. 5-1 and 5-2 are collectively a database schema showing tables in a relational database used in a preferred embodiment. While preferably, the system uses a single relational database management system to store all of the data in tables as shown in FIGS. 5-1 and 5-2, those of ordinary skill in the art will appreciate that the use of a relational database is merely exemplary, and that a non-relational database, document-oriented database, NoSQL database, or any other system for storing data can be used to store the data shown in FIGS. 5-1 and 5-2. Further, those of ordinary skill in the art will appreciate that the specific tables pictured in FIGS. 5-1 and 5-2 are merely exemplary and that the system can use other tables, other data structures, and combinations thereof to store data.

In a preferred embodiment, the VMS integrator and the custom bill pay generator are executed on the same hardware and are generated from a single code base. However, those of ordinary skill in the art will appreciate that they could be separately executed on separate machines, and could be generated from one or more separate code bases.

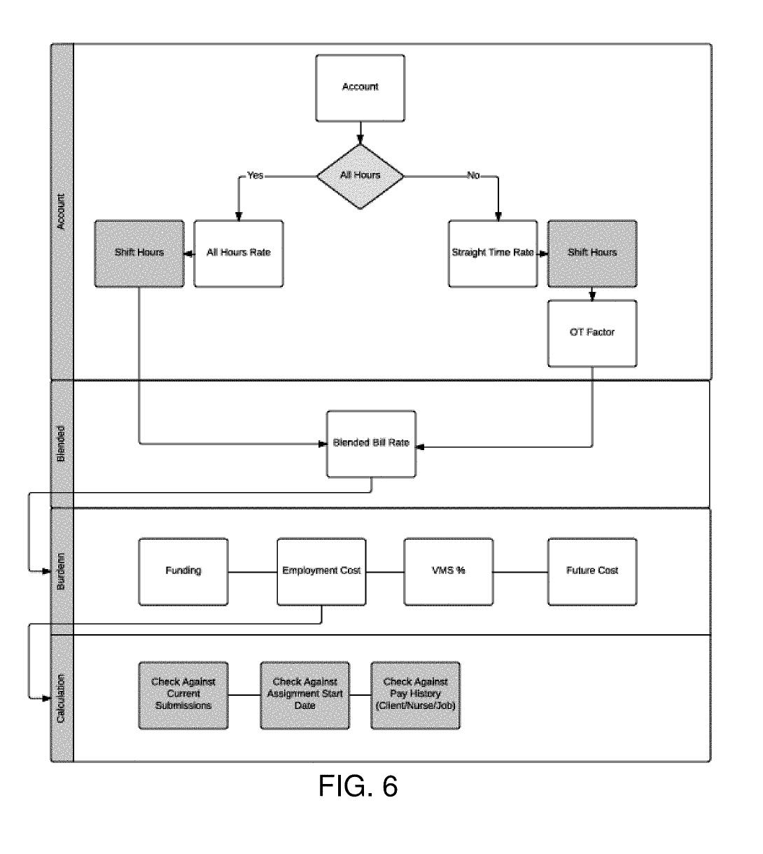

FIG. 6 is a diagram providing an overview of the factors that go into calculating the blended bill rate, and the various factors that are used to reduce the blended bill rate. As shown in FIG. 6, “burdens” are used to discount the blended bill rate, for purposes of calculating the agency's gross profit.

In a preferred embodiment, as shown in FIG. 6, there are four burdens that discount the blended bill rate: funding, employment cost, VMS percentage, and future cost. These burdens are shown in the third row in FIG. 6 and represent parameters necessary for the system to calculate how much the agency is actually willing to pay an applicant. The employment cost would include any additional expenses paid to an applicant by the agency. For example, anything that is contributed by the agency which covers the ER portion of the applicant's payroll taxes—the agency considers those as the kind of the burden or overhead, for that applicant being on payroll. Funding is another area where the costs for the agency may be based on the borrowing of payroll funds up front, so it is included as a “burden” that is a variable cost to the agency's business. After all of the burdens are considered as costs, the system figures out how much the agency can actually pay the applicant.

Preferably, a burden is usually a percentage that is set separately. For example, burdens can be set at the beginning of a period, such as a year, based on factors such as unemployment, workers comp, and the like. Then, after burdens are set at the beginning of a time period, the system can then use those burdens across all transactions. Those of ordinary skill in the art will appreciate that a burden can be adjusted at any time. Preferably, the burdens are set manually and then pulled in for use by the system.

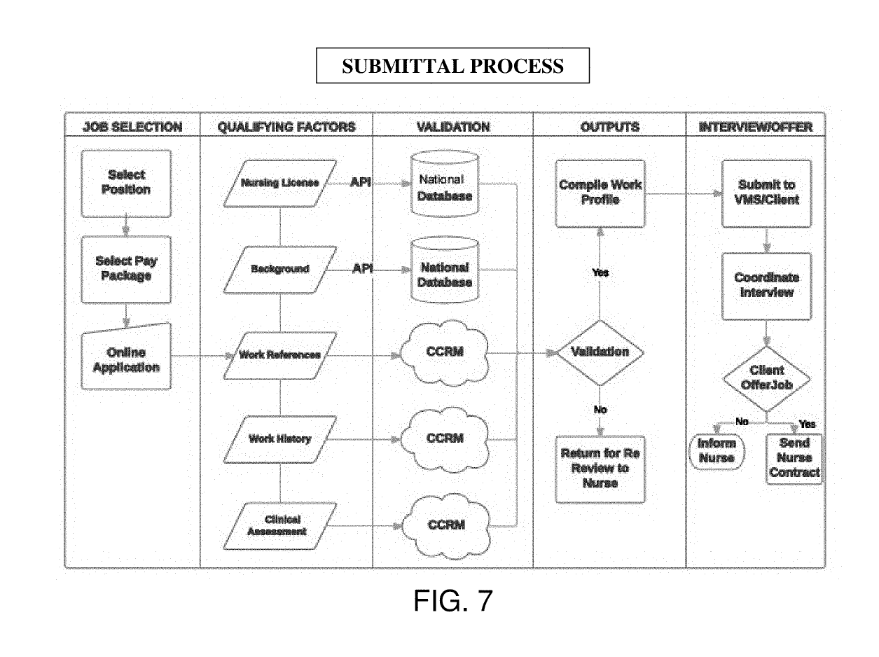

FIG. 7 is a diagram providing an overview of the submittal process, from the selection of a job to the signing of a contract, for a nurse applying for a job in accordance with a preferred embodiment. As shown in FIG. 7, preferably, a nurse selects a position, selects a pay package, and then applies for the job. Then, the nurse's qualifying factors are determined from the application, including a nursing license, background, work references, work history, and clinical assessment. In a preferred embodiment, as shown in the validation lane, the nursing license and background are verified against a national database, and the nurse's work references, work history, and clinical assessments are validated against the CCRM database. Preferably, the system can identify if there are omissions in any of the nurse's qualifying factors materials, or if the nurse does not meet any of a particular facility's criteria, in which case the system will send the materials back to the nurse for review. Those of ordinary skill will appreciate that these qualifying factors are merely exemplary, and that any other qualifying factors necessary for a particular job can be collected and validated. Thus, the system automates the receipt and validation of the qualifying factors.

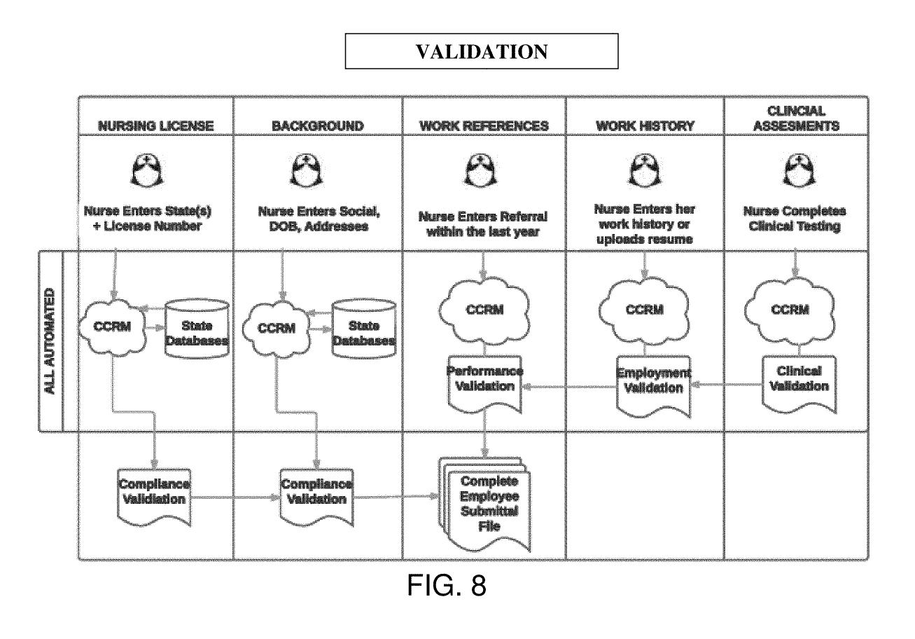

As shown in FIG. 7, after a nurse's qualifying factors are validated, a work profile is compiled and sent to the facility, preferably through a VMS. It will be appreciated by those of ordinary skill in the art that the system can automatically coordinate an interview between the facility and the applicant. Finally, as shown in FIG. 8, the nurse is informed if they did not get the job, and if the nurse did get the job, the system sends the nurse a contract.

FIG. 8 is a diagram detailing the flow of data for the process of validating qualifying factors in a preferred embodiment. As shown in FIG. 8, preferably, the CCRM database retrieves and stores nursing license and background information from state database(s) and then validates the nurse's license and background against the CCRM database. However, as shown in FIG. 8 and discussed above, the nursing license and background can also be validated against a national database. As shown in FIG. 8, the nurse's work references, work history, and clinical assessments are validated against the CCRM. Those of ordinary skill in the art will appreciate that the validation of qualifying factors against the database depicted in FIGS. 7 and 8 are merely exemplary and that the qualifying factors can be validated against any database or data storage, either internal or external to the system.

As shown in FIG. 8, for example, in validating the nurse's clinical assessment, the nurse completes clinical testing generated by the system. For example, the nurse might indicate that he has 4 years of experience working in the ER. The system would then present a set of assessments that the nurse would have to answer. The system would then grade that set of assessments and generate and assign it a score. If the nurse's assessment score meets a predetermined threshold, then that means the nurse's proficiency level for the nurse's level of experience in a specialty is acceptable, and the clinical assessments are validated; otherwise, the nurse fails validation and the file is not submitted to the facility.

After performing validation, as shown in FIG. 8, preferably, the system outputs a complete employee submittal file for submission to the facility, thereby letting the facility know that the nurse's qualifying factors have already been validated.

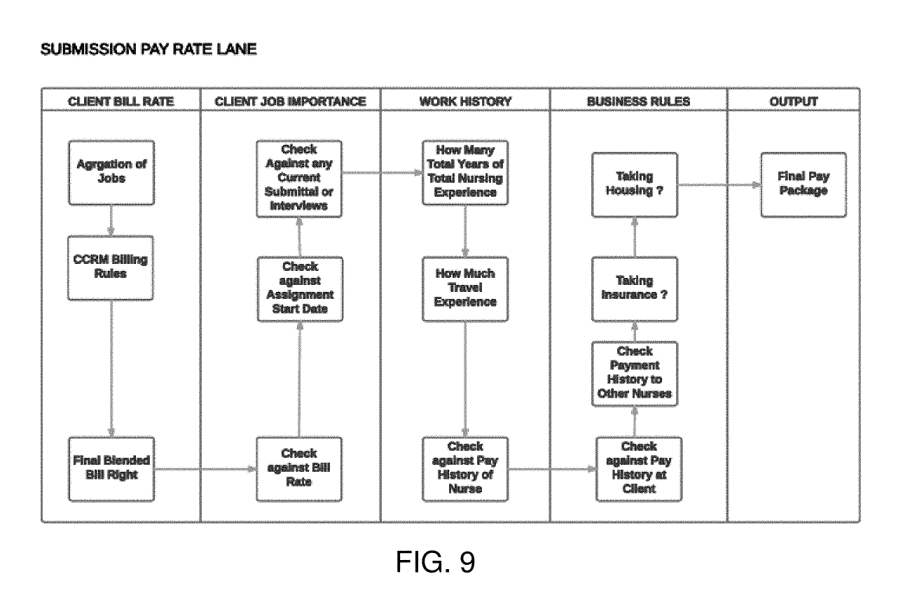

FIG. 9 is a diagram providing an overview of the steps performed by a preferred embodiment. As shown in the first column (“facility bill rate”) in FIG. 9, starting with the aggregation of jobs, as previously discussed, preferably, the jobs are retrieved and aggregated from one or more VMSs. The CCRM billing rules, which as discussed above are rules governing the calculation of a bill rate. The system then uses logic, as discussed above, to determine the final blended bill rate that can be offered to the applicant.

As shown in the second column (“facility job importance”) of FIG. 9, the blended bill rate is then checked against the bill rate typically provided by the facility. For example, if a facility normally pays a rate of $70 per hour for a particular position, but the facility has an urgent need, it might raise that bill rate to $110 per hour. The system is aware that filling this position is a high need for the facility. Then, the assignment start date is considered. For example, during Christmas, or another holiday, there may be a lower amount of usage. Thus, this check might also determine the priority of filling the position to the facility, which might affect the payout to the nurse. Further, preferably, the system checks the nurse's submission internally, including by checking current or past submissions. The system can then determine whether the agency has been able to submit a candidate to this particular job at this hospital in the past, whether there are other submissions that match the particular job criteria and the particular area. Thus, a check is performed against the importance of the area.

As shown in the third column of FIG. 9 (“work history”), preferably, the candidate's data, including the number of years of nursing experience, travel experience, and pay history, are used in calculating the final pay package. For example, a nurse with more years of nursing experience and travel experience would generally have a higher pay rate. The system can also be aware that a nurse with high levels of experience is more likely to be hired than a nurse with little experience. Then, the blended rate is checked against the pay history of the nurse, if the nurse has worked for the agency in the past. The agency can then be made aware that the nurse is being underpaid or perhaps overpaid, and can determine whether it can pay less and retain a profit margin.

As shown in the fourth column of FIG. 9, preferably, business rules are then applied to generate the final pay package. For example, one business rule checked against is whether the agency has a good history with placing applicants with a particular facility. Similarly, another business rule checks the bill rate against rates paid by the agency to other nurses historically. This then allows the agency to keep track of their placements. Say, for example, that the agency has recruiters seeking to fill 10 similar positions at a hospital, and 5 of the agency's recruiters each fill one of those positions. There might be a business issue if those 5 recruiters paid 5 different rates. Thus, the system allows the agency to limit its risk and exposure, and to provide the nurses with transparency, showing that everyone is paid in the same arena, solely based upon need at the time, years of experience, or specialty area. Finally, housing and insurance are key factors that can change the pay package. Then, the final output is the final pay package.

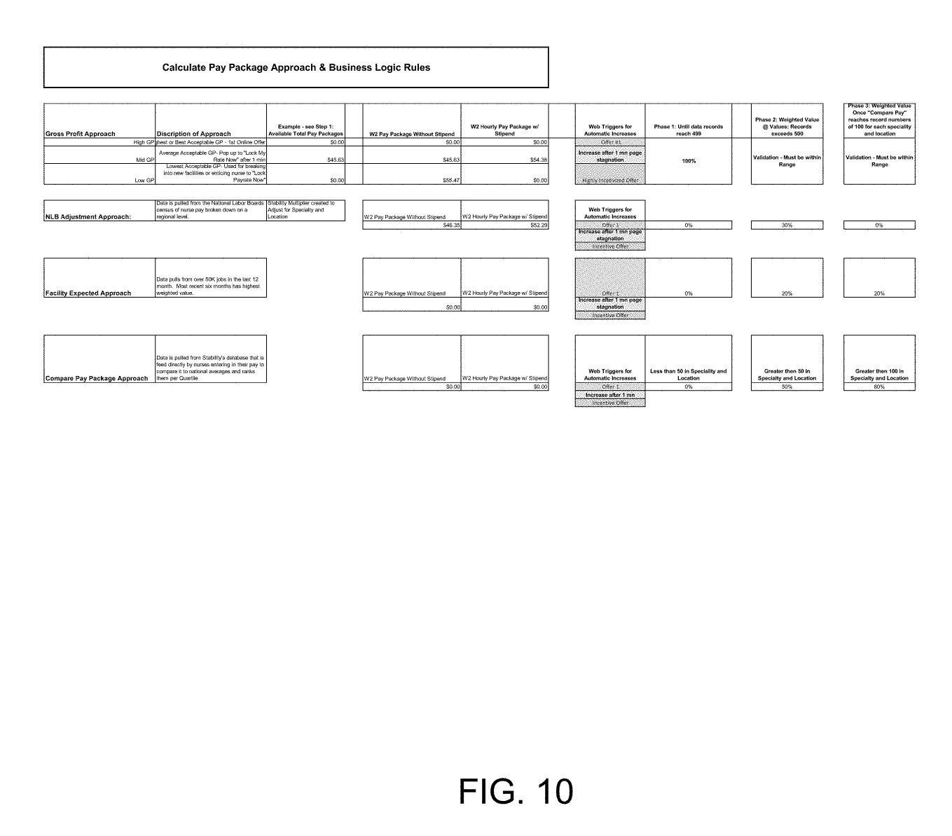

FIG. 10 is a chart providing an overview of various approaches for calculating pay packages in a preferred embodiment. As shown in FIG. 10, preferably, there are four approaches to calculating a pay package: the gross profit approach, the national labor board (NLB) adjustment approach, the facility expected approach, and the compare pay package approach. Preferably, the system can use one of these four approaches or any combination thereof. In a preferred embodiment, as shown in the three rightmost columns of FIG. 10, there are three different phases based on the number of historical pay records stored in the CCRM database. The total pay package is determined by blending some or all of the four approaches based on the phase. For example, as shown in FIG. 10, phase 1 is when there are 499 or fewer historical pay records stored in the CCRM database; in phase 1, the pay package is calculated solely based on the gross profit approach. Phase 2 occurs when there are 500 or more historical pay records in the CCRM database, and when there are more than 50 records for a given specialty and location according to the compare pay package approach. In phase 2, the gross profit approach is merely used to validate that gross profit is within a predetermined acceptable range for the agency. Instead, the NLB adjustment approach accounts for 30% of the total pay package; the facility expected approach accounts for 20% of the total pay package; and the compare pay package approach accounts for 50% of the total pay package. Phase 3 occurs when there are 100 or more records for a given specialty and location, under the compare pay package approach. In phase 3, the gross profit approach is again used only to validate that the gross profit is within a predetermined acceptable range, the facility expected approach accounts for 20% of the total pay package, and the compare pay package approach accounts for 80% of the total pay package. Those of ordinary skill in the art will appreciate that the determination and use of phases shown in FIG. 10 is merely exemplary, and that, for example, the thresholds for each of the phases may be based on different numbers of historical pay records, or on any other criteria, and that the specific percentages of each approach that go into the total pay package can be adjusted. Further, those of ordinary skill in the art will appreciate that there may be no phases at all and that the blend of approaches that goes into the total pay package calculation can be determined based on a continuous function.

Thus, preferably, as shown in FIG. 10, as more historical data is stored in the CCRM database, the system transitions from using the gross profit approach as the primary approach for calculating the total pay package, to checking gross profit merely to ensure that it falls within an acceptable range or tolerance level, and then using other approaches in calculating the total pay package. Preferably, over time, the system will adopt more of an artificial intelligence-based approach whereby the system starts to learn and then is able to refine the approaches as more data becomes available.

As shown in FIG. 10, in a preferred embodiment, the gross profit (GP) approach looks at three scenarios, high, medium, and low. GP is maximized while still taking into account the applicant's experience level and also taking into account the agency's desire to place an applicant at a given facility. Thus, for example, if the agency is highly motivated to place an applicant at a facility, it might adopt the low GP scenario, in which the gross profit received by the agency meets only a minimum baseline, and the W2 pay package is maximized. Conversely, if the agency is not motivated to fill a particular position, it may offer only pay packages maximizing the agency's gross profit. Thus, preferably, under the GP approach, the applicant selects specific job openings, and the system calculates the pay package for those job openings, based in part on the agency's GP for filling those job openings, and based in part on the agency's motivation to fill those job openings.

As shown in FIG. 10, preferably, there are also triggers for automatically increasing a pay package. By way of example, after 1 minute of stagnation by the applicant on the website, the system might automatically offer a limited-time “incentivized” offer of $1 more per hour on the applicant's W-2, or add additional money to the stipend, and then prompt the applicant to select the incentivized offer before it expires. Those of ordinary skill in the art will appreciate that incentivized offers may not only be time limited, and can also include rewards points or any other incentive.

Further, in a preferred embodiment, the demand (based on number of job openings) for applicants of a particular specialty and/or location is taken into account. For example, certain locations at certain times of the year might have a higher demand for qualified applicants. Thus, preferably, in times of greater demand, the pay package offered to qualified applicants will be greater. By way of further example, if the system notes that there are thousands of NICU jobs that need to be filled, and only hundreds of ER jobs that need to be filled, then the system would offer increased pay packages to applicants with a specialty in NICU.

Another approach used in calculating pay packages is the NLB adjustment approach, which retrieves census data provided by the NLB, broken down on a regional level. The NLB census data generally provides detailed compensation amounts for a given filed. Preferably, the data is then adjusted by multiplying by fixed multipliers depending on the specialty required and location of a particular job. In a preferred embodiment, the NLB adjustment approach also accounts for the experience level of the applicant.

As shown in FIG. 10, in a preferred embodiment, the facility expected approach is similar to the gross profit approach, except that instead of looking at a specific person and specific job, the system aggregates historical job data and pay packages, so that it is less about one specific job and looks at overall data for jobs across the board. That is, preferably, the system is able to normalize pay packages historically offered by the different facilities. For example, in the case of hospitals, differences in size between various hospitals would be taken into account and normalized, in addition to the overall compensation for a particular region and specialty. Preferably, as shown in FIG. 10, over 50,000 jobs are pulled from the database based on placements within the past year, and placements made in the past 6 months are weighted more heavily. Then, that data is used to calculate an expected pay package based on the particular facility, specialty, etc.

Preferably, as shown in FIG. 10, the compare pay package approach uses historical data collected by the agency and from prior uses of the system to compare pay packages. That is, preferably, the applicant will be able to submit his current pay information via the website, and then the applicant will be presented with a comparison between his current pay and various jobs stored in the CCRM database. Thus, as more historical pay data is added to the system through use, the more accurately the system is able to understand how nurses are getting paid.

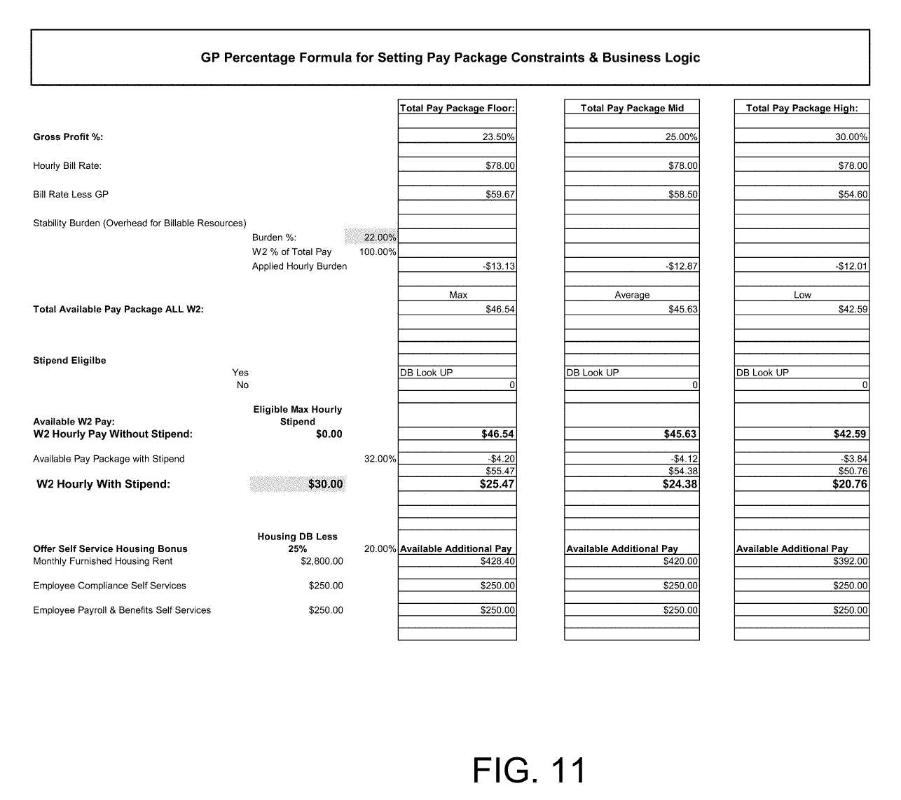

FIG. 11 is a group of tables showing the logic used to calculate a pay package under the GP approach, and in the high, mid, and low GP scenarios discussed above with regard to FIG. 10.

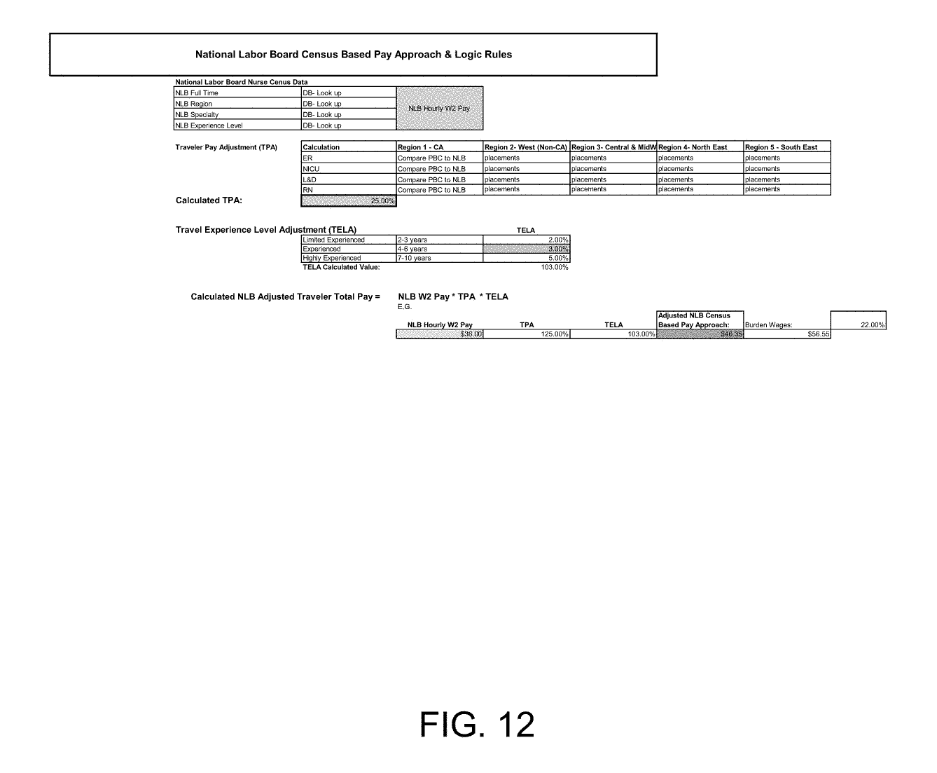

FIG. 12 is group of tables showing the logic used to calculate a pay package under the NLB approach. As shown in FIG. 12, preferably, under the NLB approach, a traveler pay adjustment (TPA) and a travel experience level adjustment (TELA) are used to calculate a pay package. A TPA is a multiplier that can be used to adjust a pay package based on the location of the job opening, and the distance traveled by the applicant. A TELA is another multiplier that can be used to adjust a pay package based on the applicant's level of experience as a travel nurse. Thus, as shown in FIG. 12, 22% is the predetermined gross profit threshold or requirement of the agency, as discussed above. The NLB hourly W2 pay for a similar position is $36. Then, based on a TPA of 25% and a TELA of 3% (for an “experienced” applicant), the adjusted NLB pay is then $46.35. Multiplying the hourly calculated eligible per diem of $27.00 by the 22% predetermined gross profit threshold gives the maximum stipend that can be offered, which is $5.94. This maximum stipend is then added to the adjusted NLB pay to calculate a total NLB pay package of $52.29.

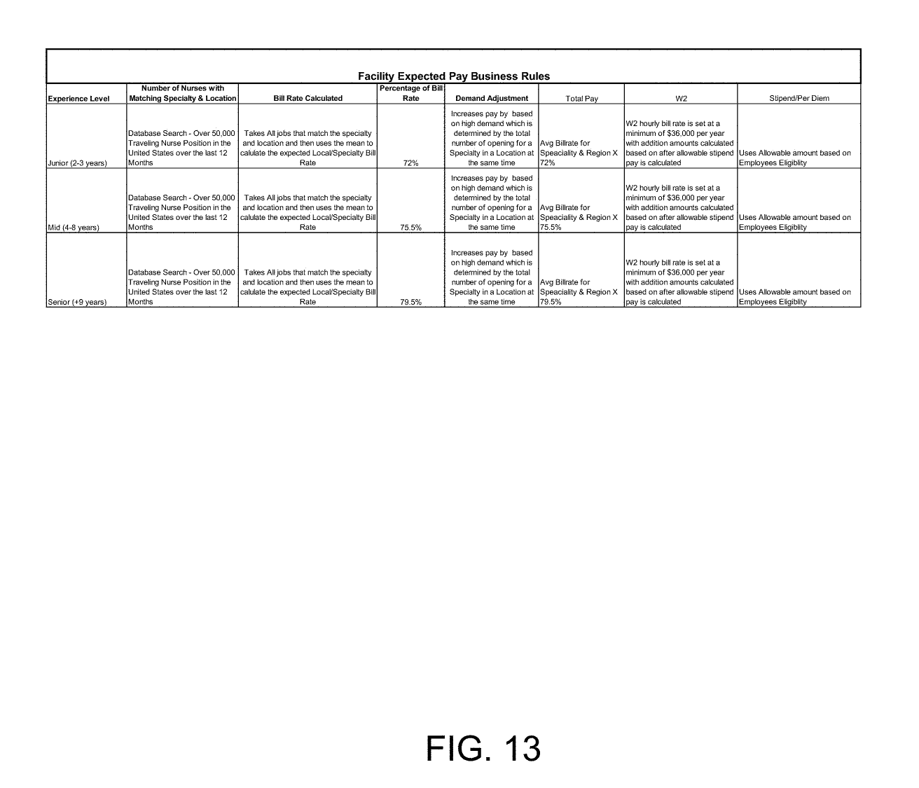

FIG. 13 is a table showing the business rules that are applied under the facility expected pay approach in a preferred embodiment. As shown in FIG. 13, preferably, the experience level of an applicant affects the multiplier for calculating total pay. However, those of ordinary skill in the art will appreciate that the specific percentages, multipliers, and experience levels shown in FIG. 13 are merely exemplary and that any percentages, multipliers, and experience levels may be used to calculate total pay under the facility expected pay approach.

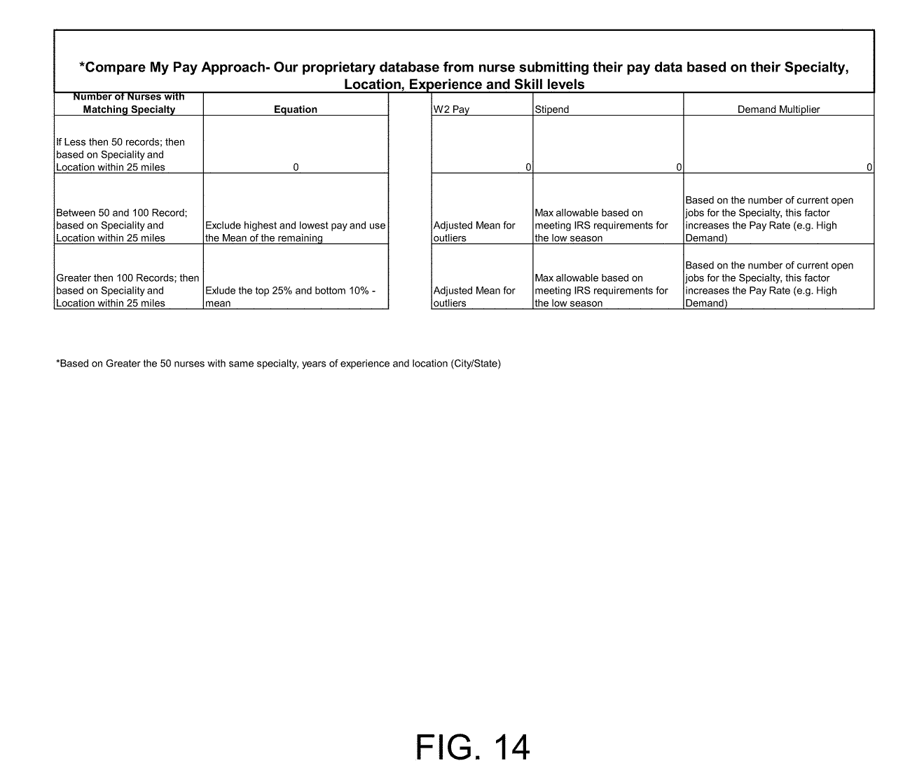

FIG. 14 is a table showing the formulas applied under the compare pay approach in a preferred embodiment.

Although the descriptions above refer to the use of preferred embodiments by an agency and applicants, it will be appreciated by those of ordinary skill in the art that preferred embodiments can also be used by third party service providers, by facilities, or any other party to an employment transaction, through the use of the website, an applications programming interface (API), or any other method of interconnectivity between the system and a third-party service. Preferably, use can be restricted to third parties who are willing to register with and provide the agency with their rates.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed, at different times. Further any specific numbers noted herein are only examples: alternative implementations may employ differing values or ranges.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges. It will be appreciated that any dimensions given herein are only exemplary and that none of the dimensions or descriptions are limiting on the present invention.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A computer-implemented system for generating customized personnel packages, comprising:
a vendor management services (VMS) integrator that aggregates jobs data pertaining to a facility's needs;
a custom customer relationship management (CCRM) database which stores information relevant to a pay package from a facility;
a bill pay generator;
wherein the VMS integrator parses out jobs details from the aggregated jobs data and reformats the jobs details into a standardized data format and stores the jobs details in the standardized data format in a VMS database;
the standardized jobs details are used by the VMS integrator to retrieve from the CCRM database the information relevant to a pay package from a facility; and
the bill pay generator applies and blends the standardized job details and the information relevant to a pay package from a facility to generate a custom pay package.

2. The system of claim 1 further comprising a website which presents to an applicant the pay package generated by the bill pay generator and wherein the website is capable of allowing an applicant to select or decline a job associated with the pay package.

3. The system of claim 2 wherein the website has the capability of asking the applicant questions necessary to generate one or more of the group consisting of: an application, a checklist, and a list of references.

4. The system of claim 1 further comprising a candidate profile generator, which generates a profile for the applicant.

5. The system of claim 1 wherein the information stored by the CCRM includes pay rules, facility contracts, and facility rate sheets for the facility associated with the standardized job details.

6. The system of claim 1 wherein the VMS Integrator receives the aggregated jobs data from the VMS database through a transmission mode selected from the group consisting of: XML feed, email, comma-separated value (CSV) feed and rich site summary (RSS) feed.

7. The system of claim 1 wherein the CCRM database stores historical rate data, and wherein the bill pay generator then uses the historical rate data in the CCRM database to generate a pay package.

8. The system of claim 1 wherein the job details include a blended rate and wherein that rate is checked by the system against the bill rate typically provided by the facility.

9. The system of claim 1 wherein the CCRM database retrieves and stores license and background information from state database(s) and then validates the license and background against the CCRM database.

10. The system of claim 1 wherein the system validates the applicant's level of experience by presenting the applicant with a set of assessments that the applicant would have to answer, then the system would grade that set of assessments and generate and assign a score, and if the applicant's assessment score meets a predetermined threshold, then that applicant's proficiency level is acceptable, and the assessments are then validated.

11. The system of claim 1 wherein the bill pay generator considers variables selected from the group consisting of: bonus, housing, insurance and travel, in creating a pay package.

12. The system of claim 1 wherein the system calculates the pay package based in part on an agency's gross profits for filling specified job openings and based in part on the agency's motivation to fill the job openings.

13. The system of claim 1 wherein the pay packages are calculated using one or more formulas selected from the group consisting of: a gross profit approach, a national labor board (NLB) adjustment approach, a facility expectation approach, and a compare pay package approach.

14. The system of claim 1 wherein a traveler pay adjustment (TPA) and a travel experience level adjustment (TELA) are used to calculate the pay package.

15. The system of claim 1 wherein a combination of data selected from the group consisting of: number of years of experience, travel experience, and pay history, are used in calculating the pay package.

16. The system of claim 1 wherein history with placing applicants with a particular facility and rates paid by the agency to other nurses historically are used in calculating the pay package.

17. The system of claim 2 wherein the system increases the pay package by offering a limited-time incentivized offer which prompts the applicant to select the incentivized offer before it expires.

18. The system of claim 1 wherein market demand based on number of job openings for applicants of a particular specialty or location are used the calculate the pay package.

19. The system of claim 2 further comprising an online document dashboard for receiving and verifying certifications, licenses, and forms, and for the applicant to digitally sign any documents.

20. The system of claim 3 wherein the applicant is presented with an employee contract and the applicant is then onboarded with payroll and compliance, ensuring that the applicant meets all of the facility's criteria, and wherein an agency can submit its bill or invoice to the facilities through the system.

21. A computer-implemented system for enrolling a job applicant and generating an application package, comprising:
a vendor management services (VMS) integrator that aggregates jobs data pertaining to a facility's needs;
a custom customer relationship management (CCRM) database which stores information relevant to a pay package from a facility;
a portal which allows the applicant to input his specialty and compare the rate he is receiving at his current workplace or in his current location or area, to the pay package for a potentially new job placement wherein the applicant also has the option of inputting a shift time;
wherein the jobs data are retrieved from the VMS integrator based on the applicant's inputted information and presented for comparison;
a business rate logic is applied and goes into enrollment interview processing where gross profit drivers are exhibited; and
wherein logical decisions are made based on whether the system has any matches that are comparable to the applicant's current job, based on information inputted by the applicant.

22. The system of claim 21 further comprising a business process outsourcing (BPO) unit for providing backend support, data entry, and validation in order to generate data that is blended to produce a blended rate.

23. The system of claim 21 wherein decisions are made through the CCRM which lead to a processing logic which uses historical pay packages and existing pay packages to present a pay package.

24. The system of claim 21 wherein a compliance function is performed to update information regarding the applicant.

25. The system of claim 21 further comprising an online document dashboard for receiving and verifying certifications, licenses, and forms, and for the applicant to digitally sign any documents.

26. The system of claim 21 wherein it is capable of operating in an automated fashion by directly presenting a pay package to a facility through a VMS.

27. The system of claim 21 wherein the portal allows the applicant to input his preferences for the potentially new job placement.

28. A computer network-implemented process for generating customized personnel packages, comprising:
receiving and aggregating jobs data pertaining to a facility's needs;
storing the jobs data and information relevant to a pay package from the facility;
generating a custom pay package based on the jobs data and the information relevant to the pay package from the facility;
presenting the custom pay package to an applicant via a website.
